(19) United States
(12) Patent Application Publication
(10) Pub. No.: US 2024/0359627 A1
(43) Pub. Date: Oct. 31, 2024

(54) STEP ASSEMBLY FOR A WORK VEHICLE

(71) Applicant: CNH Industrial America LLC, New Holland, PA (US)

(72) Inventors: Daniel Alan Morey, Mundelein, IL (US); John Joseph Schrepferman, Saint Charles, IL (US); Shane Michael Scott, Bolingbrook, IL (US); Sean O'Halloran, Elmhurst, IL (US)

(21) Appl. No.: 18/649,264

(22) Filed: Apr. 29, 2024

Related U.S. Application Data
(60) Provisional application No. 63/462,769, filed on Apr. 28, 2023.

(51) Int. Cl. B60R 3/00

(52) U.S. Cl. CPC B60R 3/007

(57) ABSTRACT

A step assembly for a work vehicle includes a top portion configured to engage a base portion of the step assembly while in an engaged state. The top portion is configured to be disposed above the base portion while in the engaged state. The top portion is also configured to cover an operational component of the work vehicle while in the engaged state. The top portion is also configured to be disposed on a ground surface while in a disengaged state to support a standing operator in a stable configuration and to elevate the standing operator relative to the ground surface.

### CROSS-REFERENCE TO RELATED APPLICATION

This application claims priority from and the benefit of U.S. Provisional Application Ser. No. 63/462,769, entitled “STEP ASSEMBLY FOR A WORK VEHICLE”, filed Apr. 28, 2023, which is hereby incorporated by reference in its entirety.

### BACKGROUND

The present disclosure relates generally to a step assembly for a work vehicle.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Certain work vehicles, such as tractors, harvesters, and sprayers, have a step assembly configured to enable an operator to climb a side of the work vehicle to reach a cab of the work vehicle. In addition, certain work vehicles are configured to store one or more electrical components within an interior cavity of the work vehicle.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In certain embodiments, a step assembly for a work vehicle includes a top portion configured to engage a base portion of the step assembly while in an engaged state. The top portion is configured to be disposed above the base portion while in the engaged state. The top portion is also configured to cover an operational component of the work vehicle while in the engaged state. The top portion is also configured to be disposed on a ground surface while in a disengaged state to support a standing operator in a stable configuration and to elevate the standing operator relative to the ground surface.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of a work vehicle having an embodiment of a step assembly;

FIG. 2 is a perspective view of the step assembly of FIG. 1, in which a top portion is engaged with a base portion in an engaged state;

FIG. 3 is a perspective view of the step assembly of FIG. 1, in which the top portion is disposed on a ground surface in a disengaged state;

FIG. 4 is a top perspective view of the top portion of the step assembly of FIG. 1; and

FIG. 5 is a bottom perspective view of the top portion of the step assembly of FIG. 1.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

In some work vehicles, electrical components may be stored in a step assembly which may be climbed by an operator into a cab of the work vehicle. In certain embodiments, an electrical component may be accessed by a removal of a portion of the step assembly. The portion of the step assembly removed may be configured to support an operator standing on a top surface of the removed portion, such that the removed portion may be used as a stepping stool to enable the operator to reach portions of the work vehicle that would otherwise be difficult for the operator to reach. For example, in certain embodiments disclosed herein, a step assembly for a work vehicle includes a top portion configured to engage a base portion of the step assembly while in an engaged state. The top portion is configured to be disposed above the base portion while in the engaged state, and the top portion is configured to cover an operational component (e.g., electrical component, etc.) of the work vehicle while in the engaged state. Furthermore, the top portion is configured to be disposed on a ground surface while in a disengaged state to support a standing operator in a stable configuration and to elevate the standing operator relative to the ground surface.

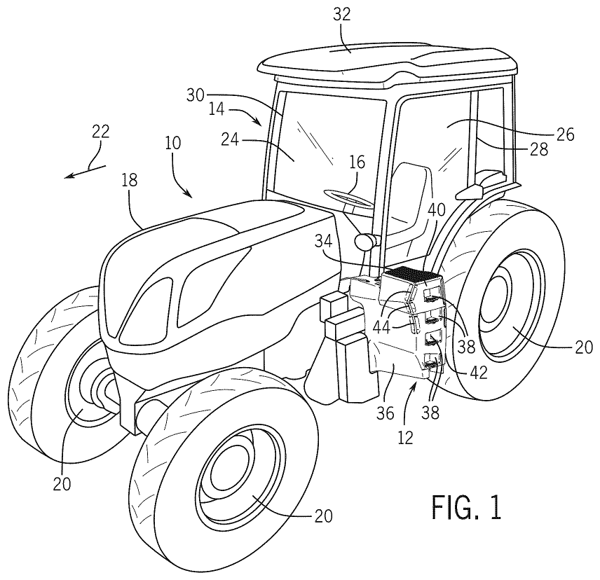

FIG. 1 is a perspective view of an embodiment of a work vehicle 10 having an embodiment of a step assembly 12. In the illustrated embodiment, the work vehicle 10 includes a cab 14 configured to house an operator. A steering wheel 16 is disposed within the cab 14 to facilitate control of the work vehicle 10. The cab 14 may also house additional controls to enable the operator to control various functions of the work vehicle (e.g., movement of a tool coupled to the work vehicle, speed of the work vehicle, etc.). In the illustrated embodiment, the work vehicle 10 includes a hood 18 configured to cover an engine, a transmission, other systems of the work vehicle 10, or a combination thereof. In addition, the work vehicle 10 includes wheels 20 configured to be driven by the engine, thereby driving the work vehicle 10 through a field and/or along a road in a direction of travel 22. While the work vehicle 10 includes wheels 20 in the illustrated embodiment, in other embodiments, the work vehicle may include tracks or a combination of wheels and tracks. Furthermore, while the work vehicle 10 is a tractor in the illustrated embodiment, in other embodiments, the work vehicle may be a harvester, a sprayer, a bulldozer, or any other suitable type of work vehicle.

In the illustrated embodiment, the cab 14 of the work vehicle 10 includes a windshield 24 and a door 26. The windshield 24 substantially blocks dirt, debris, and water from entering an interior of the cab 14. In addition, the door 26 selectively facilitates ingress and egress of the operator. In the illustrated embodiment, the door 26 is rotatably coupled to a frame of the cab 14 by a hinge 28 that enables the door 26 to rotate between the illustrated closed position and an open position. In the illustrated embodiment, the cab 14 also includes a windshield wiper 30. The windshield wiper 30 is configured to remove water from the windshield 24, thereby enhancing operator visibility. The work vehicle 10 also includes a roof panel 32 disposed above the cab 14.

In the illustrated embodiment, the step assembly 12 includes a top portion 34 disposed above and engaged with a base portion 36. The top portion 34 includes a recess 38 extending into a side wall 40 of the top portion 34, and the base portion 36 includes recesses 38 extending into side wall 42 of the base portion 36, thereby forming steps of the step assembly 12. Additionally, the top portion 34 and the base portion 36 include grab handles 44. The recesses 38, in conjunction with the grab handles 44, are configured to enable an operator to mount (e.g., climb) the step assembly 12 to provide a user with a vantage point for cleaning windows, servicing wipers, and/or servicing lights. In certain embodiments, the step assembly 12 may be configured to enable the operator to mount the step assembly 12 and move into the cab 14. In certain embodiments, the step assembly 12 may be formed from polymer (e.g., plastic) and, in certain embodiments, manufactured via rotational molding. In certain embodiments, the base portion 36 may additionally function as a tank for storing a liquid. In certain embodiments, the step assembly 12 may be coupled to a right side of the work vehicle 10, a left side of the work vehicle 10, or a combination thereof. The step assembly 12 is described in further detail herein.

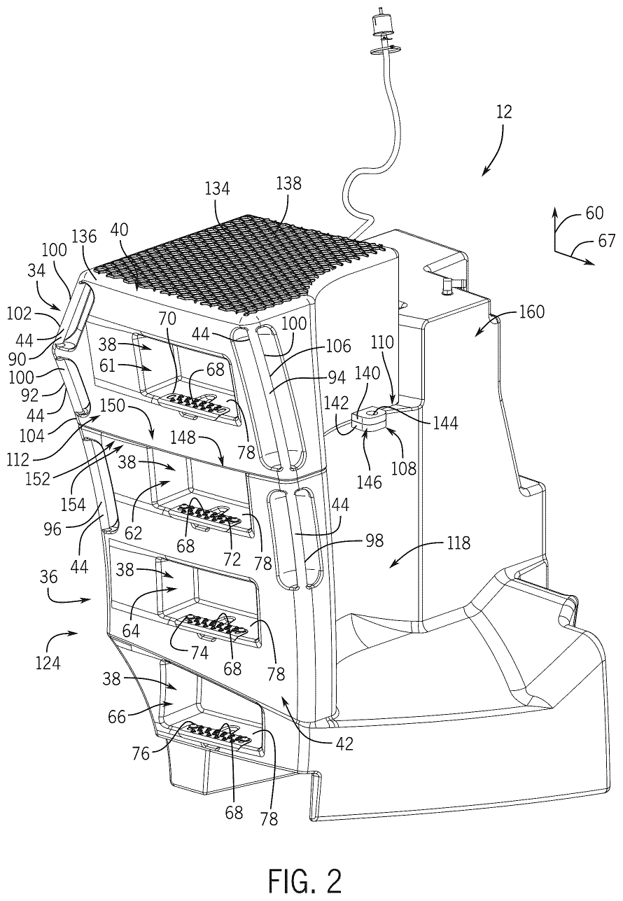

FIG. 2 is a perspective view of the step assembly 12 of FIG. 1, in which the top portion 34 is engaged with the base portion 36 in an engaged state. In the illustrated embodiment, the top portion 34 is configured to engage the base portion 36 while in an engaged (e.g., connected) state. Additionally, the top portion 34 is disposed above the base portion 36 with respect to a vertical direction 60. In the illustrated embodiment, the top portion 34 and the base portion 36 collectively include the recesses 38 (e.g., recesses 61, 62, 64, and 66) extending into the side walls 40 and 42 of the top portion 34 and base portion 36, respectively. As shown, the top portion 34 includes the recess 61, and the base portion 36 includes recesses 62, 64, and 66. The recesses 38 are configured to substantially align with one another with respect to a longitudinal direction 67 while the top portion 34 is in the engaged state. In the illustrated embodiment, the step assembly 12 includes a grate 68 (e.g., grates 70, 72, 74, and 76) disposed on a bottom surface 78 of each of the recesses 38. However, in other embodiments, at least one of the grates may be omitted. In the illustrated embodiment, the step assembly 12 also includes grab handles 44 (e.g., grab handles 90, 92, 94, 96, and 98) disposed on edges 100 (e.g., edges 102, 104, and 106) of the top portion 34 and the base portion 36. In the illustrated embodiment, the edges 100 are substantially vertical edges (e.g., extending substantially along the vertical direction 60). However, in other embodiments, the edges may extend along other suitable direction(s). For example, in certain embodiments, at least one edge on which a grab handle is disposed may include a horizontal edge spanning a width of the step assembly. While the step assembly includes grab handles in the illustrated embodiment, in other embodiments, the grab handles may be omitted. The step assembly 12 also includes a lock assembly 108 disposed at an interface 110 between the top portion 34 and the base portion 36. However, in other embodiments, the lock assembly may be omitted. As shown, the step assembly 12 also includes front side 112, side surface 118, and lateral side 124.

In the illustrated embodiment, the grab handles 44 and the recesses 38 are configured to support an operator (e.g., an adult human) via retention of a front portion of a foot of the operator in at least one of the recesses 38 while the operator concurrently grasps at least one of the grab handles 44 with at least one hand for support and/or stabilization. The grates 68 disposed in the recesses 38 are configured to increase friction between a bottom of the foot (e.g., shoe, sole of shoe) step assembly 12. Due to the substantial longitudinal alignment of the recesses 38, the recesses 38 and the grab handles 44 may enable the operator to climb the step assembly 12 from a ground surface to the cab of the work vehicle.

In the illustrated embodiment, the top portion 34 includes recess 61 and the base portion 36 includes recesses 62, 64, and 66. In certain embodiments, the top portion 34 may include additional recesses 38 and corresponding grates 68. In certain embodiments, the base portion 36 may include additional or fewer recesses 38 and corresponding grates 68. In the illustrated embodiment, the top portion 34 includes grab handles 90, 92, and 94, and the base portion 36 includes grab handles 96 and 98. In certain embodiments, the top portion 34 and/or the base portion 36 may include additional or fewer grab handles 44.

In the illustrated embodiment, the step assembly 12 includes a tread layer 138 disposed on or integrally formed into a top surface 134 of a top wall 136 of the top portion 34. The tread layer 138 is configured to increase friction (e.g., increasing the static friction coefficient and/or the dynamic friction coefficient) between the step assembly 12 and the sole of the foot of the operator while standing on the top portion 34. The tread layer 138 may include a pattern formed on the top surface 134 (e.g., during a rotational molding manufacturing process). For example, the pattern may include lines (e.g., horizontal lines or lines forming polygonal shapes) configured to increase the friction (e.g., roughness) of the top surface 134. In certain embodiments, the tread layer 138 may include a separate layer formed from a material having a high coefficient of static friction and/or a high coefficient of dynamic friction (e.g., rubber, silica).

In certain embodiments, the lock assembly 108 includes a tab 140 coupled to the top portion 34 and a tab 142 coupled to the base portion 36 along the interface 110. The tab 142 is substantially aligned with the tab 140 when the top portion 34 is in the engaged state. The tabs 140 and 142 include holes 144 and 146, respectively. The holes 144 and 146 are substantially aligned with one another while the tabs 140 and 142 are substantially aligned. The substantial alignment of the holes 144 and 146 may enable an operator to insert a lock (e.g., combination lock, pad lock) through the holes 144 and 146, thereby securing the top portion 34 to the base portion 36. In certain embodiments, the lock assembly 108 may be configured to lock the top portion 34 to the base portion 36, retain the top portion 34 on the base portion 36, or a combination thereof. While the lock assembly includes tabs with holes in the illustrated embodiment, in other embodiments, the lock assembly may include other suitable locking element(s) (e.g., alone or in combination with the tabs having holes), such as a latch, a protrusion/recess assembly, other suitable locking element(s), or a combination thereof. In certain embodiments, multiple locking assemblies may be used for locking (e.g., retaining, securing) the top portion 34 to the base portion 36. Furthermore, in certain embodiments, the lock assembly may be omitted.

In the illustrated embodiment, an outer perimeter 148 of a bottom surface 150 of the top portion 34 aligns with (e.g., matches) an outer perimeter 152 of a top wall 154 of the base portion 36. However, in certain embodiments, the outer perimeter of the top portion may not align with the outer perimeter of the base portion. For example, one or more portions the outer perimeter of the top portion may not align with the outer perimeter of the base portion. In certain embodiments, the bottom surface 150 of the top portion 34 may be configured to align with the top wall 154 base portion 36 via one or more alignment features (e.g., protrusions, recesses).

In the illustrated embodiment, the recess 62 of the base portion 36 disposed directly beneath (e.g., adjacent) the top portion 34 is not a full (e.g., enclosed, encircled) recess, but instead opens to the top wall 154 of the base portion 36. Accordingly, an operator may remove the top portion 34 from the base portion 36 by reaching into the recess 62 (e.g., via the operator's hands) and pulling upward on the bottom surface 150 of the top portion 34.

In the illustrated embodiment, the base portion 36 includes a vertical extension 160 disposed behind the top portion 34 in the engaged state. In certain embodiments, the vertical extension 160 is configured to provide structural support to the top portion 34 in the engaged state. In certain embodiments, the vertical extension 160 may be configured to physically contact the top portion 34 in the engaged state. In certain embodiments, the vertical extension may be omitted.

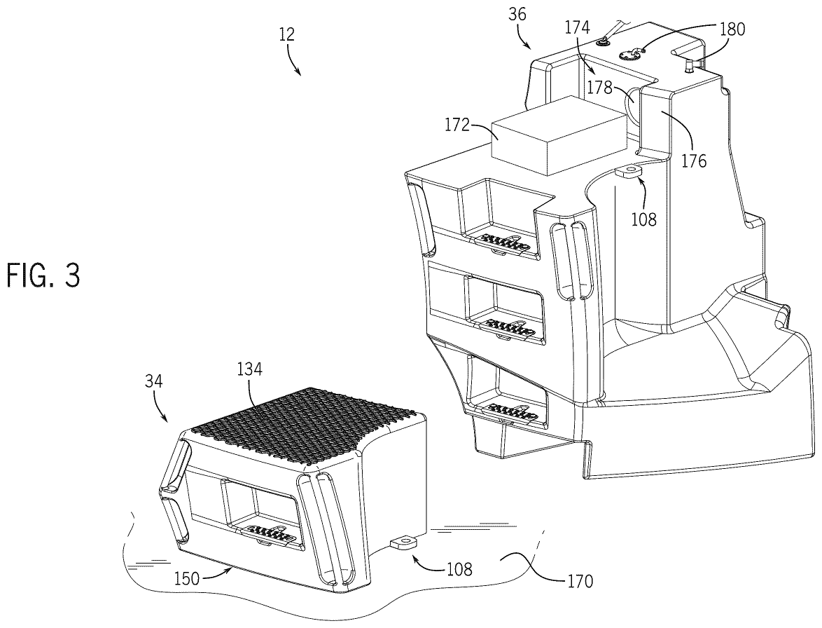

FIG. 3 is a perspective view of an embodiment of the step assembly 12 of FIG. 1, in which the top portion 34 is disposed on a ground surface 170 in a disengaged state. As shown in the illustrated embodiment, the top portion 34 is configured to be disposed on the ground surface 170 while in the disengaged state to support a standing operator in a stable configuration and to elevate the operator relative to the ground surface 170. For example, upon the top portion 34 being disposed on the ground surface 170 in the disengaged state, the operator may step onto the top surface 134 of the top portion 34 in order to achieve a height advantage for reaching higher locations on the work vehicle.

In certain embodiments, the locking assembly 108 may first be unlocked prior to disengaging the top portion 34 from the base portion 36. In the illustrated embodiment, the top portion 34 is disposed on the ground surface 170 via the bottom surface 150 of the top portion 34 making contact with (e.g., abutting) the ground surface 170. In the illustrated embodiment, the front side 112 of the top portion 34 is facing in a substantially similar direction as the front side 112 of the base portion 36. However, the front side 112 of the top portion 34 may face in a different direction than the front surface 112 of the base portion 36.

In the illustrated embodiment, an electrical component 172 (e.g., battery) stored underneath the top portion 34 in a cavity of the top portion 34 becomes accessible to the operator in response to the disengagement of the top portion 34 from the base portion 36. That is, while in the engaged state, the top portion 34 is configured to cover (e.g., shield) the electrical component 172. In certain embodiments, the top portion 34 may be configured to shield the electrical component 172 from environmental factors such as moisture and solar radiation. In response to removal of the top portion 34 from the base portion 36, the electrical component 172 may become exposed and/or accessible to the operator for maintenance and/or replacement. While the top portion 34 covers the electrical component 172 in the illustrated embodiment, in other embodiments, the top portion may cover other suitable operational component(s) of the work vehicle (e.g., alone or in addition to the electrical component), such as hydraulic component(s), mechanical component(s), other suitable component(s), or a combination thereof.

In the illustrated embodiment, the vertical extension 160 includes a cavity 174 disposed between sections of a front surface 176 of the vertical extension 160. In certain embodiments, the cavity 174 may be disposed behind the top portion 34 in the engaged state to enable the operator to access the electrical component 172 covered by the top portion 34 while in the engaged state. The vertical extension 160 also includes a channel 178 (e.g., conduit) disposed through a back surface of the cavity 174. In certain embodiments, the channel 178 may be configured to mount (e.g., couple) the base portion 36 of the step assembly 12 to the work vehicle. In certain embodiments, the channel 178 may be configured to form a conduit for wires from the electrical component 172 to another portion of the work vehicle. The vertical extension 160 also includes inlets/outlets 180 configured to transfer a liquid into and/or out of the interior of the base portion 36. In certain embodiments, the inlets/outlets 180 may be omitted.

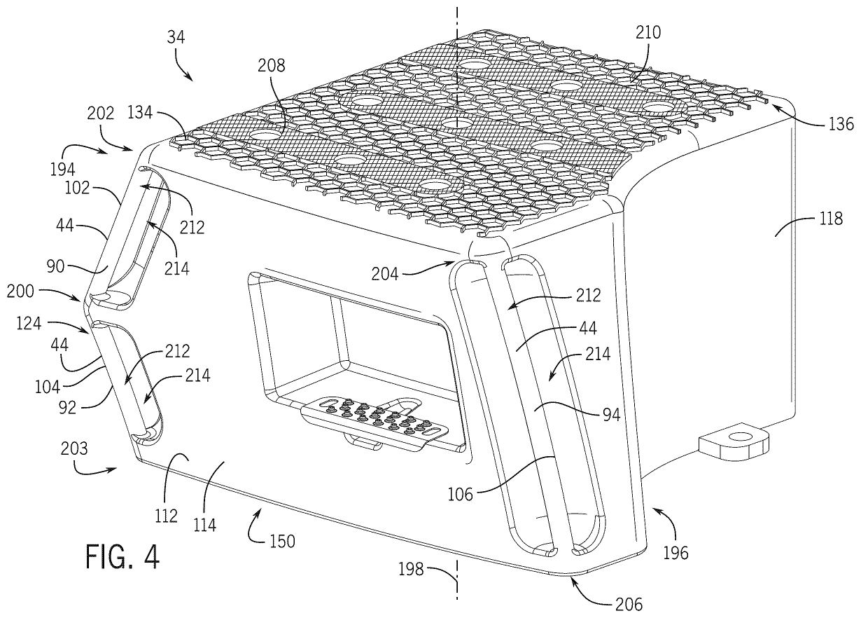

FIG. 4 is a top perspective view of the top portion 34 of the step assembly 12 of FIG. 1. As discussed herein, the top portion 34 includes grab handles 90, 92, and 94. In the illustrated embodiment, grab handles 90 and 92 are disposed on edges 102 and 104, respectively, of a side 194 of the top portion 34, and grab handle 94 is disposed on an edge 106 of a side 196 of the top portion 34. In certain embodiments, the grab handles 90, 92, and/or 94 may be disposed in other suitable locations on the top portion 34.

In the illustrated embodiment, the edges 102 and 104 are angled outwardly relative to a vertical central axis 198 of the top portion 34 such that an intersection 200 of the edges 102 and 104 is disposed at a greater distance from the vertical central axis 198 compared to an intersection 202 between the edge 102 and the top surface 134 and an intersection 203 between the edge 104 and the bottom surface 150 of the top portion 34. In the illustrated embodiment, the edge 106 is angled inwardly such that an intersection 204 between the edge 106 and the top surface 134 is closer to the central axis 198 than an intersection 206 between the edge 106 and the bottom surface 150.

In the illustrated embodiment, the top wall 136 of the top portion 34 includes a plurality of through holes 208 extending from the top surface 134 of the top wall 136 to a top surface of a cavity of the top portion 34, as discussed in further detail herein. In certain embodiments, the top portion 34 may be formed with the through holes 208 during a rotational molding procedure, such that the through holes 208 include side walls upon completion of the procedure. The side walls of the through holes 208 formed via rotational molding may be configured to provide structural support to the top portion 34 by structurally connecting the top wall 136 of the top portion 34 to the top surface of the cavity. In the illustrated embodiment, the through holes 208 are disposed through the top wall 136 of the top portion 34. In certain embodiments, the through holes 208 may be disposed through other wall(s) (e.g., side wall(s)) alone or in combination with the top wall. Furthermore, in certain embodiments, the through holes may be omitted.

In the illustrated embodiment, the top portion 34 includes one or more strips 210 (e.g., plates) disposed on the top surface 134 or embedded in the top wall 136. For example, the top surface 134 may include channels configured to retain the strips 210. In certain embodiments, the strips 210 may be formed from a hard and/or stiff material (e.g., metal, composite) configured to mitigate bowing (e.g., bending) of the top wall 136 in response to a downward load (e.g., a standing operator) being exerted onto the top wall 136. In certain embodiments, the strips 210 may be coupled to the top surface 134 via one or more fasteners disposed in the through holes 208. In certain embodiments, the strips 210 may be embedded into the top wall 136 during a rotational molding process. In certain embodiments, the tread layer 138 may be applied (e.g., integrally formed into) the strips 210 such that the tread layer 138 is contiguous on the top surface 134. In certain embodiments, the strips 210 are embedded beneath the tread layer 138, such that the thread layer 138 covers the strips 210. In certain embodiments, the strips 210 may be omitted.

In the illustrated embodiment, each grab handle 44 includes a handle portion 212 (e.g., portion which may be grasped by the operator) formed via a through hole 214 (e.g., through slot) extending from the front side 112 to either lateral side 118 or lateral side 124. In certain embodiments, the through hole(s) 214 may extend from the front side 112 to either lateral side 118 or lateral side 124 (e.g., disposed in the top portion 34). In certain embodiments, the through hole(s) may extend from the front surface of the base portion to a respective side surface of the base portion.

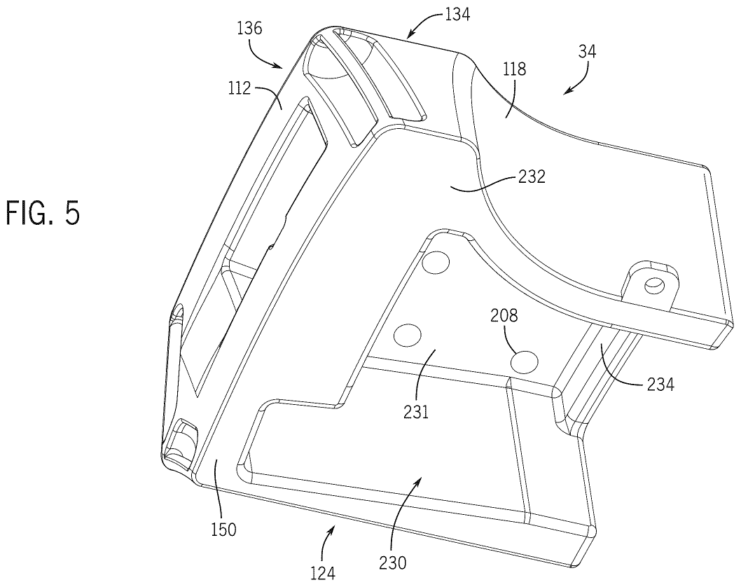

FIG. 5 is a bottom perspective view of the top portion 34 of the step assembly of FIG. 1. In the illustrated embodiment, the top portion 34 includes a cavity 230 extending to the bottom surface 150 of the top portion 34. The cavity 230 is configured to accommodate the operational (e.g., electrical) component while the top portion 34 is in the engaged state, such that the top portion 34 covers the operational component. In the illustrated embodiment, the through holes 208 extend from the top surface 134 of the top wall 136 to the top surface 231 of the cavity 230.

The top portion 34 includes the bottom surface 150 (e.g., flat bottom surface). In the illustrated embodiment, the bottom surface 150 borders the cavity 230 and is contiguous (e.g., a single surface). In certain embodiments, the bottom surface 150 may be formed from multiple flat bottom surfaces (e.g., noncontiguous). The bottom surface 150 is configured to make contact with (e.g., abut) the ground surface while the top portion 34 is in the disengaged state and also contact the top surface of the base portion while in the engaged state. The bottom surface 150 is configured to provide the stable configuration of the top portion 34 when the operator stands on the top surface 134 of the top portion 34 in the disengaged state.

In the illustrated embodiment, the top portion 34 includes a rear wall 234 of the cavity 230. As shown, the rear wall 234 extends a portion of a distance spanning from the top surface 231 to the bottom surface 232. The rear wall 234 is configured to provide structural support to the top portion 34 to support the operator standing on the top surface 134 while the top portion is in the disengaged state. In certain embodiments, the rear wall 234 may extend from the top surface 231 to the bottom surface 150. The thicknesses of the walls of the front side 112, lateral side 118, lateral side 124, and the real wall 234 are configured to provide strength for supporting the operator when standing on the top surface 134 of the top portion 34.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. A step assembly for a work vehicle comprising a top portion configured to engage a base portion of the step assembly while in an engaged state;
wherein the top portion is configured to be disposed above the base portion while in the engaged state, and the top portion is configured to cover an operational component of the work vehicle while in the engaged state;
wherein the top portion is configured to be disposed on a ground surface while in a disengaged state to support a standing operator in a stable configuration and to elevate the standing operator relative to the ground surface.

2. The step assembly of claim 1, wherein the top portion comprises one or more grab handles disposed on one or more edges of the top portion.

3. The step assembly of claim 2, wherein each grab handle of the one or more grab handles comprises a handle portion formed via a through hole extending from a front surface of the top portion to a side surface of the top portion.

4. The step assembly of claim 3, wherein the top portion comprises at least one first recess, and the at least one first recess is configured to longitudinally align with at least one second recess of the base portion while the top portion is in the engaged state.

5. The step assembly of claim 4, wherein the one or more grab handles and the at least one first recess are configured to support an operator via retention of a front portion of at least one foot of the operator in the at least one first recess and the operator concurrently grasping the one or more grab handles with at least one hand.

6. The step assembly of claim 1, wherein the top portion comprises a tread layer disposed on or integrally formed into a top surface of a top wall of the top portion, wherein the tread layer is configured to increase a friction coefficient between the top surface and at least one foot of the standing operator.

7. The step assembly of claim 1, comprising a locking assembly configured to:
lock the top portion to the base portion;
retain the top portion on the base portion;
or a combination thereof.

8. The step assembly of claim 1, wherein the top portion has a cavity extending to a bottom surface of the top portion, and the cavity is configured to accommodate the operational component while the top portion is in the engaged state.

9. The step assembly of claim 8, wherein the top portion has at least one through hole extending through a top wall from a top surface of the top portion to a top surface of the cavity.

10. A step assembly for a work vehicle comprising:
a base portion; and
a top portion configured to engage the base portion while in an engaged state;
wherein the top portion is configured to be disposed above the base portion while in the engaged state, and the top portion is configured to cover an operational component of the work vehicle while in the engaged state;
wherein the top portion is configured to be disposed on a ground surface while in a disengaged state to support a standing operator in a stable configuration and to elevate the standing operator relative to the ground surface.

11. The step assembly of claim 10, wherein the base portion comprises one or more first grab handles, wherein the top portion comprises one or more second grab handles, or a combination thereof.

12. The step assembly of claim 11, wherein each grab handle of the one or more grab handles comprises a handle portion formed via a through hole extending from a front surface of the top portion to a side surface of the top portion.

13. The step assembly of claim 12, wherein the top portion comprises at least one first recess, and the at least one first recess is configured to longitudinally align with at least one second recess of the base portion while the top portion is in the engaged state.

14. The step assembly of claim 13, wherein the one or more grab handles and the at least one first recess are configured to support an operator via retention of a front portion of at least one foot of the operator in the at least one first recess and the operator concurrently grabbing the one or more grab handles with at least one hand.

15. The step assembly of claim 10, wherein the top portion comprises a tread layer disposed on or integrally formed into a top surface of a top wall of the top portion, wherein the tread layer is configured to increase friction between the top surface and at least one foot of the standing operator.

16. The step assembly of claim 10, comprising a locking assembly configured to:
lock the top portion to the base portion;
retain the top portion on the base portion;
or a combination thereof.

17. A step assembly for a work vehicle comprising:
a base portion; and
a top portion having a flat bottom surface and configured to engage the base portion in an engaged state;
wherein the top portion is configured to be disposed above the base portion while in the engaged state, and the top portion is configured to cover an operational component of the work vehicle while in the engaged state;
wherein the flat bottom surface of the top portion is configured to be disposed on a ground surface while in a disengaged state to support a standing operator in a stable configuration and to elevate the standing operator relative to the ground surface.

18. The step assembly of claim 17, wherein a first outer perimeter of the flat bottom surface matches a second outer perimeter of a top surface of the base portion.

19. The step assembly of claim 17, wherein the top portion has a cavity extending to a bottom surface of the top portion, and the cavity is configured to accommodate the operational component while the top portion is in the engaged state.

20. The step assembly of claim 17, wherein the top portion comprises a rear wall of the cavity, and the rear wall extends a portion of a distance spanning from a top surface of the cavity to the flat bottom surface.
